(19) United States
(12) Patent Application Publication
(10) Pub. No.: US 2004/0040602 A1
(43) Pub. Date: Mar. 4, 2004

(54) Reservoir assembly for fuel pump module

(76) Inventor: Robert L. Farrar, Flint, MI (US)

Correspondence Address: VINCENT A. CICHOSZ, DELPHI TECHNOLOGIES, INC., Legal Staff, Mail Code: 480-410-202, P.O. Box 5052, Troy, MI, 48007-5052, US

(21) Appl. No.: 10/235,016

(22) Filed: Sep. 4, 2002

(51) Int. Cl. F02M 37/04

(52) U.S. Cl. 137/565.17

(57) ABSTRACT

A reservoir assembly for a fuel pump module includes a plurality of sections. The sections include at least a bottom section and a top section joined together to provide a predetermined height and volume.

### TECHNICAL FIELD

The present invention relates generally to fuel pump modules for vehicles and, more particularly, to a reservoir assembly for a fuel pump module in a fuel tank of a vehicle.

### BACKGROUND OF THE INVENTION

It is known to provide a fuel tank for a vehicle to hold fuel to be used by an engine of the vehicle. In some vehicles, the fuel tank includes a fuel pump module disposed therein with a removable cover sealed to the top of the fuel tank. The fuel pump module typically includes a fuel reservoir and an electrical fuel pump disposed in the fuel reservoir.

An example of a fuel pump module is disclosed in U.S. Pat. No. 5,218,942 to Coha et al. In this patent, the fuel pump module includes a fuel pump disposed in the fuel reservoir. Typically, the fuel reservoir has a single height and capacity.

Therefore, it is desirable to provide a new fuel reservoir for a fuel pump module in a fuel tank of a vehicle. It is also desirable to provide a fuel reservoir for a fuel pump module that has a variable height. It is further desirable to provide a fuel reservoir for a fuel pump module that has a variable capacity.

### SUMMARY OF THE INVENTION

It is, therefore, one object of the present invention to provide a new reservoir assembly for a fuel pump module in a fuel tank of a vehicle.

It is another object of the present invention to provide a reservoir assembly for a fuel pump module that has a variable height and capacity.

To achieve the foregoing objects, the present invention is a reservoir assembly for a fuel pump module including a plurality of sections. The sections include at least a bottom section and a top section joined together to provide a predetermined height and volume.

One advantage of the present invention is that a new reservoir assembly is provided for a fuel pump module in a fuel tank of a vehicle. Another advantage of the present invention is that the reservoir assembly allows for fast prototype or production reservoir assemblies that can vary in capacity. Yet another advantage of the present invention is that the reservoir assembly allows multiple fuel capacities for reservoir assemblies that can be easily obtained to study low fuel handling characteristics of a vehicle. Still another advantage of the present invention is that the reservoir assembly has a variable height and variable pivot. A further advantage of the reservoir assembly is that it is modular.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a fragmentary elevational view of a reservoir assembly, according to the present invention, illustrated in operational relationship with a fuel tank.

FIG. 2 is an exploded perspective view of the reservoir assembly of FIG. 1.

FIG. 3 is an exploded perspective view of another embodiment, according to the present invention, of the reservoir assembly of FIG. 1.

FIG. 4 is an enlarged exploded fragmentary view of a portion of the reservoir assembly of FIG. 3.

### DESCRIPTION OF THE PREFERRED EMBODIMENT

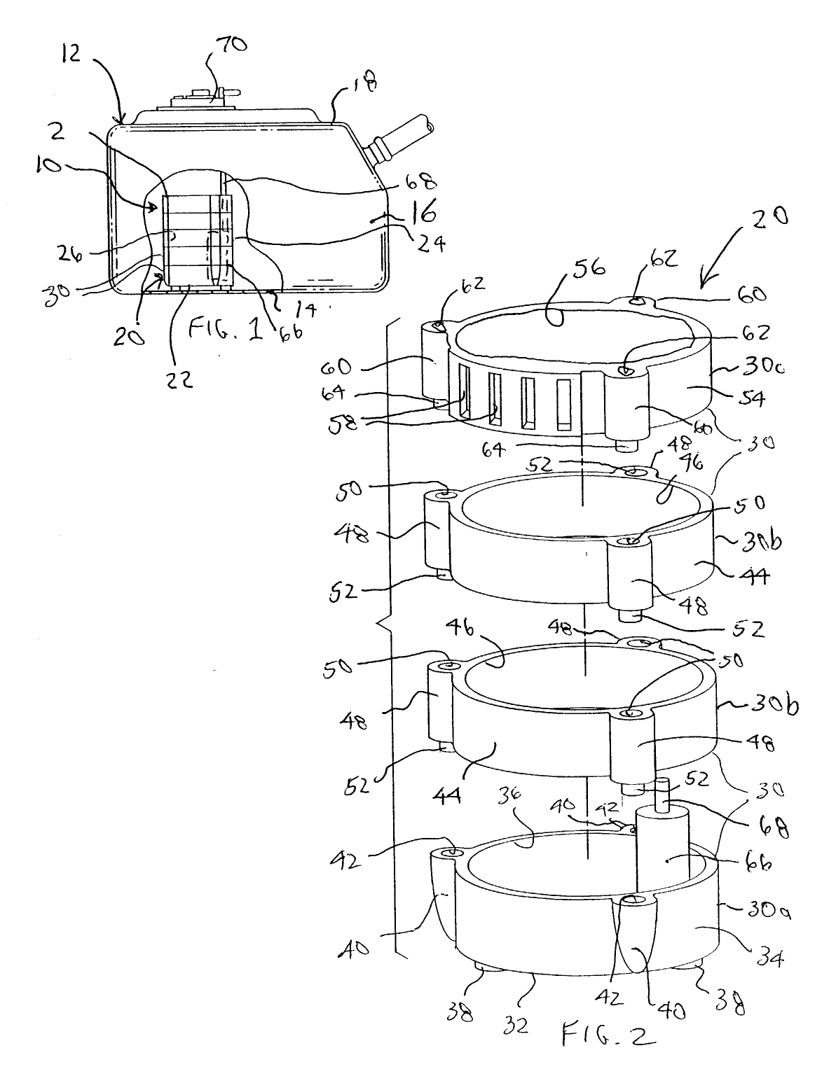

Referring to the drawings and in particular FIGS. 1 and 2, one embodiment of a fuel pump module 10, according to the present invention, is shown for a fuel tank, generally indicated at 12, in a vehicle (not shown). In this embodiment, the fuel tank 12 has a bottom wall 14 and a side wall 16 around a periphery of the bottom wall 14 and extending generally perpendicular thereto. The fuel tank 12 has a top wall 18 around a periphery of the side wall 16 and extending generally perpendicular thereto. The fuel tank 12 is made of a rigid material such as plastic. It should be appreciated that, except for the fuel pump module 10, the fuel tank 12 is conventional and known in the art.

The fuel pump module 10 includes a fuel reservoir assembly, according to the present invention and generally indicated at 20, to hold fuel disposed inside the fuel tank 12. The reservoir assembly 20 has a bottom portion 22 and an annular side portion 24 extending generally perpendicularly from the bottom portion 22 to form a chamber 26. The reservoir assembly 20 is generally bucket-shaped and open at a top end 28 thereof, which defines an overflow fuel level in the reservoir assembly 20. The fuel reservoir 18 also has an inlet (not shown) formed in the bottom portion 22. The reservoir assembly 20 is made of a rigid material such as plastic. It should be appreciated that the top end 28 is above the highest level of new fuel in the fuel tank 12 so that there is little or no in-and-out flow over the top. It should also be appreciated that the top end 26 may be partially closed to minimize splash-over while still venting the interior of the reservoir assembly 20.

The reservoir assembly 20 also includes a plurality of individual building blocks or sections 30 stacked vertically or axially and joined together to provide a predetermined or desired height and volume. The sections 30 include at least a base or bottom section 30a. The bottom section 30a has a bottom wall 32. The bottom wall 32 is generally planar in circular in shape. The bottom section 30a also has an annular side wall 34 extending generally perpendicular upwardly to the bottom wall 32 to form a cavity 36 therein. The bottom wall 32 has at least one, preferably a plurality of feet 38 extending downwardly therefrom and spaced thereabout to support the bottom wall 32 above the bottom wall 14 of the fuel tank 12. The bottom section 30a includes at least one, preferably a plurality of connecting members 40 extending radially outwardly and axially along the side wall 34. The connecting members 40 are spaced circumferentially about the side wall 34. Each of the connecting members 40 has a cavity 42 extending axially therein for a function to be described. The bottom section 30a is made of a rigid material such as plastic. The bottom section 30a is a monolithic structure being integral, unitary, and one-piece. It should be appreciated that the bottom section 30a holds a jet pump assembly (not shown) and ceramic cardholder (not shown).

The sections 30 may include at least one, preferably a plurality of height adjuster or center sections 30b. The center section 30b is generally tubular in shape and has a generally circular cross sectional shape. The center section 30b has an annular side wall 44 to form an aperture 46 extending axially therethrough. The center section 30b includes at least one, preferably a plurality of connecting members 48 extending radially outwardly and axially along the side wall 44. The connecting members 48 are spaced circumferentially about the side wall 34. Each of the connecting members 48 has a cavity 50 extending axially therein from a top end thereof for a function to be described. Each of the connecting members 48 has a projection 52 extending axially from a bottom end thereof to be received in a corresponding cavity 42,50 for a function to be described. The center section 30b is made of a rigid material such as plastic. The center section 30b is a monolithic structure being integral, unitary, and one-piece. It should be appreciated that the center sections 30b are fillers that can be placed anywhere to achieve a required volume of the reservoir assembly 20.

The sections 30 include at least an upper or top section 30c. The top section 30c is generally tubular in shape and has a generally circular cross sectional shape. The top section 30c has an annular side wall 54 to form an aperture 56 extending axially therethrough. The side wall 54 includes at least one, preferably a plurality of bars 58 spaced circumferentially and extending axially therealong to allow a card (not shown) to slide on. Preferably, the bars 58 are generally rectangular in shape. The top section 30c includes at least one, preferably a plurality of connecting members 60 extending radially outwardly and axially along the side wall 54. The connecting members 60 are spaced circumferentially about the side wall 54. Each of the connecting members 60 has a cavity 62 extending axially therein from a top end thereof for a function to be described. Each of the connecting members 60 has a projection 64 extending axially from a bottom end thereof to be received in a corresponding cavity 42,50 for a function to be described. The top section 30c is made of a rigid material such as plastic. The top section 30c is a monolithic structure being integral, unitary, and one-piece. It should be appreciated that a fuel pump retainer (not shown) and fuel pump holder (not shown) is attached to the top section 30c. It should also be appreciated that the top section 30c acts as a pivot point section and is located where needed to position a float arm (not shown) at a middle of fuel level.

Referring to FIGS. 1 and 2, the fuel pump module 10 also includes a fuel pump 66 disposed in the reservoir assembly 20. The fuel pump 66 is of a high-pressure electric fuel pump type. The fuel pump 66 extends axially and is generally cylindrical and circular cross-sectional shape. The fuel pump 66 is mounted to the bottom section 30a by suitable means (not shown). The fuel pump 66 is connected by a hose 68 to a fuel module cover 70 to communicate fuel to an engine (not shown) of the vehicle. It should be appreciated that the fuel pump 66 is also connected by wires (not shown) to a source of electrical power such as a controller (not shown). It should also be appreciated that the fuel pump 66 is conventional and known in the art.

Referring to FIG. 1, the fuel pump module 10 is illustrated with the reservoir assembly 20 assembled and disposed in the fuel tank 12. To assemble the reservoir assembly 20, the sections 30 are snapped together with the projections 62,64 being disposed in the cavities 42,50 to provide a variable height and variable pivot point modular reservoir assembly 20. It should be appreciated that variability is achieved from a height of the center sections 30b. It should also be appreciated that the height of the sections 30 may vary.

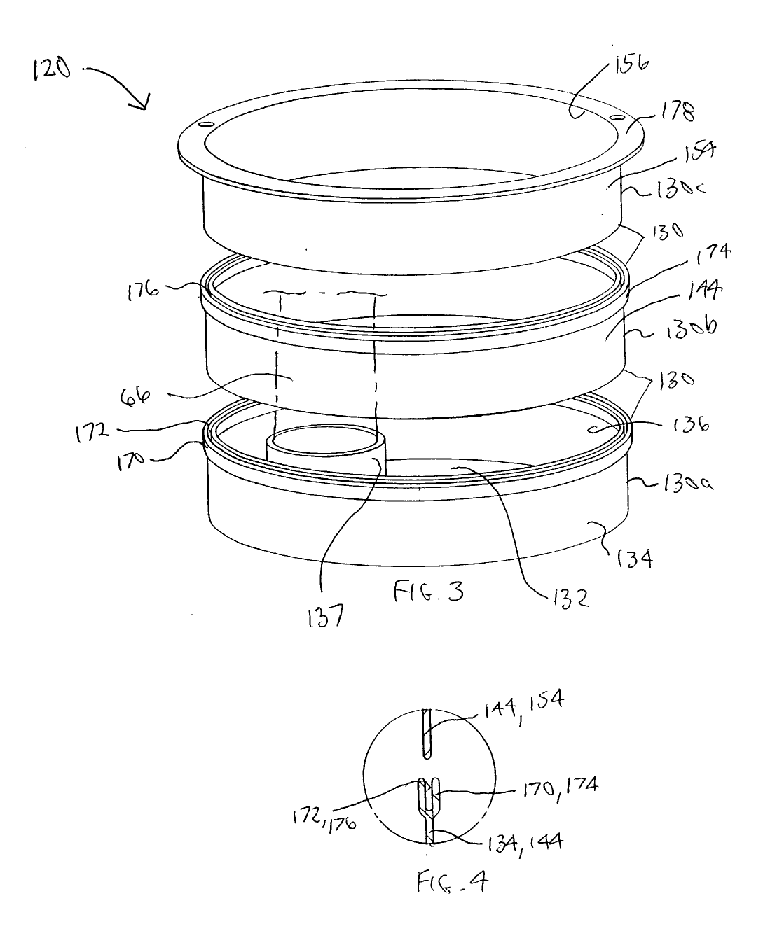

Referring to FIGS. 3 and 4, another embodiment, according to the present invention, of the reservoir assembly 20 is shown. Like parts of the reservoir assembly 20 have like reference numerals increased by one hundred (100). In this embodiment, the reservoir assembly 120 includes a plurality of sections 130. The sections include a bottom section 130a, center sections 130b, and top section 130c. The bottom section 130a has a bottom wall 132 and an annular side wall 134 extending generally perpendicular upwardly to the bottom wall 132 to form a cavity 136 therein. The bottom wall 132 has an annular wall 137 extending generally perpendicularly upwardly from the bottom wall 132 and into the cavity 136 to the fuel pump 66. The bottom section 130a includes an annular flange 170 extending around the periphery of the side wall 134 at an upper end thereof. The flange 170 has a groove 172 extending axially therein to form the flange 170 with a generally “U” shaped cross-section for a function to be described. It should be appreciated that the fuel pump 66 is held in place by the bottom section 130a.

The sections 130 may include at least one, preferably a plurality of height adjuster or center sections 130b. The center section 130b is generally tubular in shape and has a generally circular cross sectional shape. The center section 130b has an annular side wall 144 to form an aperture 146 extending axially therethrough. The center section 130b includes an annular flange 174 extending around the periphery of the side wall 144 at an upper end thereof. The flange 174 has a groove 176 extending axially therein to form the flange 174 with a generally “U” shaped cross-section for a function to be described.

The sections 130 include at least an upper or top section 130c. The top section 130c is generally tubular in shape and has a generally circular cross sectional shape. The top section 130c has an annular side wall 154 to form an aperture 156 extending axially therethrough. The top section 130c includes a flange 178 extending radially outwardly and generally perpendicular to the side wall 154. It should be appreciated that the top section 130c sets on a reservoir lip.

To assemble the reservoir assembly 120, the sections 130 are snapped together with the side walls 144,154 being disposed in the grooves 172,176 of the flanges 170,174 to provide a variable height and variable pivot point modular reservoir assembly 120. It should be appreciated that variability is achieved from a height of the center sections 130b.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A reservoir assembly for a fuel pump module comprising:
a plurality of sections, said sections comprising at least a bottom section and a top section joined together to provide a predetermined height and volume.

2. A reservoir assembly as set forth in claim 1 wherein said sections are stacked vertically.

3. A reservoir assembly as set forth in claim 1 wherein said sections include at least one center section disposed between said bottom section and said top section.

4. A reservoir assembly as set forth in claim 1 wherein said bottom section includes at least one connecting member having a cavity therein.

5. A reservoir assembly as set forth in claim 4 wherein said top section includes at least one connecting member having a projection extending therefrom, said projection being disposed in said cavity.

6. A reservoir assembly as set forth in claim 1 wherein said bottom section includes at least one flange having a groove therein.

7. A reservoir assembly as set forth in claim 6 wherein said top section includes a side wall extending therefrom, said side wall having a portion being disposed in said groove.

8. A reservoir assembly as set forth in claim 1 wherein said top section comprises an annular side wall and a flange extending radially from said side wall.

9. A reservoir assembly as set forth in claim 3 wherein said center section includes at least one connecting member having a cavity therein.

10. A reservoir assembly as set forth in claim 9 wherein said at least one connecting member has projection extending therefrom.

11. A reservoir assembly as set forth in claim 1 wherein said sections are made of a plastic material.

12. A fuel pump module for a fuel tank of a vehicle comprising:
a fuel reservoir comprising a plurality of individual sections, said sections comprising at least a bottom section and a top section stacked vertically and joined together to provide a predetermined height and volume; and
a fuel pump disposed in said fuel reservoir and mounted to said bottom section.

13. A fuel pump module as set forth in claim 12 wherein said sections include at least one center section disposed between said bottom section and said top section.

14. A fuel pump module as set forth in claim 12 wherein said bottom section includes at least one connecting member having a cavity therein.

15. A fuel pump module as set forth in claim 14 wherein said top section includes at least one connecting member having a projection extending therefrom, said projection being disposed in said cavity.

16. A reservoir assembly as set forth in claim 12 wherein said bottom section includes at least one flange having a groove therein.

17. A fuel pump module as set forth in claim 16 wherein said top section includes a side wall extending therefrom, said side wall having a portion being disposed in said groove.

18. A fuel pump module as set forth in claim 11 wherein said top section comprises an annular side wall and a flange extending radially from said side wall.

19. A fuel pump module as set forth in claim 13 wherein said center section includes at least one connecting member having a cavity therein and a projection extending therefrom.

20. A fuel tank assembly for a vehicle comprising:
a fuel tank;
a fuel reservoir disposed in said fuel tank;
said fuel reservoir comprising a plurality of individual sections, said sections comprising at least a bottom section and a top section stacked vertically and joined together to provide a predetermined height and volume; and
a fuel pump disposed in said fuel reservoir and mounted to said bottom section.
